(19) United States
(12) Patent Application Publication
(10) Pub. No.: US 2007/0290555 A1
(43) Pub. Date: Dec. 20, 2007

(54) Power adaptor

(75) Inventor: Barry Caren, Beverly Hills, CA (US)

Correspondence Address: SAM TALPALATSKY, 10867 CLOVERHURST WAY, SAN DIEGO, CA, 92130, US

(73) Assignee: MAGNADYNE CORPORATION, COMPTON, CA (US)

(21) Appl. No.: 11/713,885

(22) Filed: Mar. 5, 2007

Related U.S. Application Data
(60) Provisional application No. 60/784,067, filed on Mar. 17, 2006.

(51) Int. Cl. H02J 1/00

(52) U.S. Cl. 307/31

(57) ABSTRACT

A power adaptor configured for vehicle or wall power converting the power to one or more voltage sources for user accessories. Accessory power is regulated by a first regulator sending the power to an accessory connector, such as a miniature USB, SCI connector, or any other type of connector. Power is channeled via a conductor, such as a coiled cord. An inline a USB port is positioned between the power adaptor and accessory connector. The USB port is configured for providing power to a USB compatible accessory. The USB port is connected to a second regulator configured in a form of an IC or a voltage divider calculated to bring a voltage level to each of the data pins of the USB port. The second regulator is positioned in proximity with the USB port thus eliminating the need to provide extra conductors from the first regulator in order to condition the data lines at the USB port.

### CROSS-REFERENCE TO RELATED APPLICATIONS

This application claims priority to co-pending United States provisional application entitled, “Power Adaptor,” having Ser. No. 60/784,067, filed Mar. 17, 2006, which application is entirely incorporated herein by reference.

### BACKGROUND

1. Field

The disclosed embodiments relate generally to charging and power adapting devices.

2. Discussion of the Relevant Art

Personal appliances, such as cell phones, are widely proliferated throughout our society. More and more functionality, such as voice, text, photography, calendaring and email access, is being integrated within portable devices such as cell phones and personal entertainment devices (iPod®, MP3 players). These units are evolving into portable, handheld devices often referred to as a personal digital appliance (hereafter collectively the “PDA”). Users are used to carrying their PDA's in their pockets, pocket books and generally about their person, allowing them to receive calls, send/receive email, access their personal information, listen to music, download information and programs, and the like.

Power sources for PDAs allow time-limited use. Periodically these devices need new batteries or a recharge. Commonly a PDA or its batteries are recharged by coupling to a main power source such as a 120 VAC or 12 VDC wall or car power outlet. The main power source is conditioned to parameters suitable for the PDA and after a period of time the battery is recharged and uncoupled.

The challenge arises when multiple devices compete for a limited number of main power outlets. This is more common in a vehicle, which typically has one or two 12 VDC outlets. One way to overcome this limitation is to provide a plug-in device that expands the number of power terminals by expanding the 12 VDC power connections. Similarly, in the 120 VAC applications power outlet extensions are applied. Challenge often arises during travel or in places where extensions are not available, unsightly, undesirable or impractical. Vehicle applications in particular are problematic, as such power extensions may be unsightly, incompatible with the cabin, blocking access to controls, or presenting a potential safety hazard.

Recognizing the need for power sources, a trend in the industry is to build devices, including PDAs, that are USB compatible. USB is a universal serial bus that allows devices to communicate and draw power over an industry standard specification and mechanical configuration. Accordingly, in low current applications, device manufacturers are designing recharge components compatible with USB ports and parameters. Therefore, one could recharge a PDA by plugging it into a USB port connected to a computer. Other devices on the market also provide USB power connections built into wall chargers and car chargers.

Accordingly, there is a need to provide for a means to share a limited number of power ports for a number of devices, whether or not compatible with the USB specification.

### SUMMARY

The disclosed embodiments illustrate and describe a power adaptor designed to provide one or more conditioned in-line USB power ports in combination with other power charging ports. The disclosed embodiments utilize a regulator, such as a voltage divider in proximity to the USB port(s); thereby eliminating one or more additional pairs of wires/conductors running from the power source to the USB port(s).

In another embodiment, disclosed is a device comprising a Y-configuration connected to a power source on the central leg, splitting the power to one or more USB ports on the one hand and one or more other ports on the other, wherein as above, the regulating means, such as a resistance network comprising a voltage divider, is positioned at the USB port; thereby eliminating one or more additional pairs of wires running from the power source to the USB port(s).

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a block diagram of one of the disclosed embodiments comprising a vehicle power source plug connected to a USB port in line with a power connector;

FIG. 2 is a schematic/block diagram comprising a resistive network connected to the USB port conditioning the data lines of the USB port;

FIG. 3 is a schematic/block diagram of FIG. 1 with further detail of the USB port comprising the resistive network conditioning the data lines of the USB port;

FIG. 4 is an alternate embodiment, similar to FIG. 3 configured for AC voltage applications;

FIG. 5 is a schematic/block diagram of FIG. 3, wherein USB and accessory connectors have different power requirements;

FIG. 6 is a schematic/block diagram of FIG. 4 wherein USB and accessory connector have different power requirements;

FIG. 7 is an alternate embodiment using a Y-configuration with the power leg connected to one or more USB ports on the one hand and one or more power connectors on the other hand.

### DETAILED DESCRIPTION

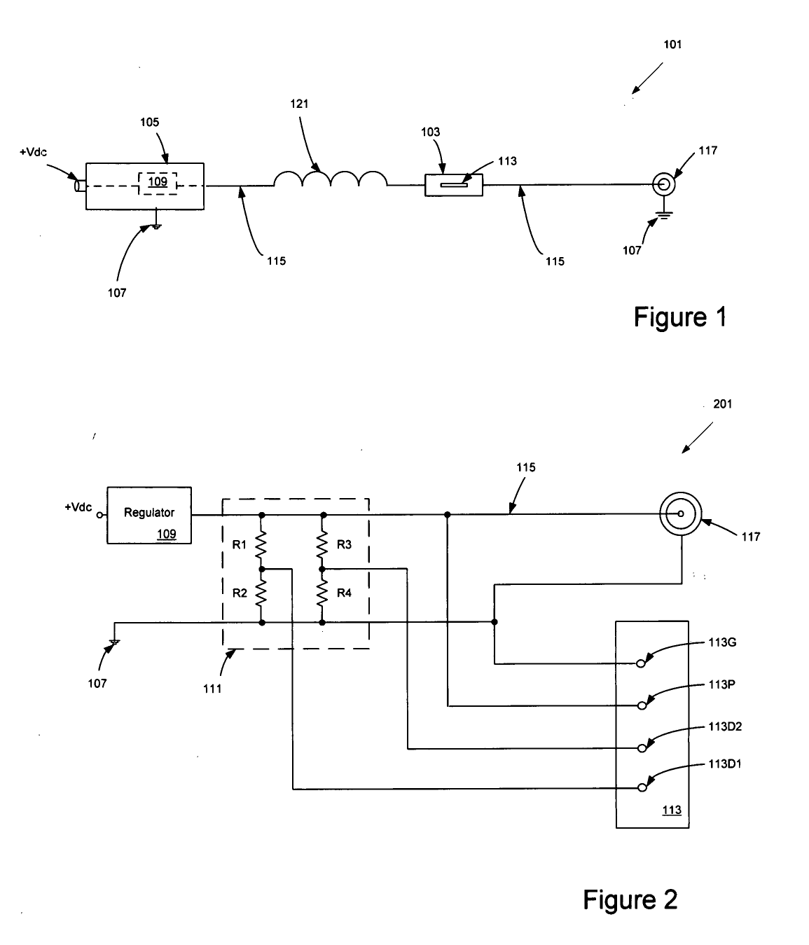

Shown in FIG. 1, is a representative embodiment of the disclosed power adaptor 101 configured for vehicle applications. Power Adaptor 101 generally comprises a power plug 105 configured in a male fashion for engagement with a cigarette lighter in a vehicle. Power plug 105 typically employs a positive power node at its tip for connection to 12 VDC power and one or more side connectors connected to vehicle ground 107. In applications for charging PDA's, one or more regulators 109 are employed to condition the 12 VDC power from the vehicle power to a suitable voltage for the PDAs. For example, in applications suitable for many communication devices such as cell phones, the desirable power levels are around 5 VDC +/−a tolerance such as 5%, as an example. Yet other devices/PDAs may have other power specifications. Power regulators 109 are commercially available, often in a form of an IC. Once the power is conditioned, it is connected via a conductor/cord 115 to one or more power connectors 117 which is compatible with a target PDA. In some configurations conductor 115 is coiled as illustrated by 121. This conserves room and helps eliminate undesirable clutter.

Also shown in FIG. 1 is a USB port 103 in line and between power plug 105 and power connector 117. As will be described in further detail below, USB port 103 is configured to provide power to USB compatible devices. Such devices mate to the port and pin configuration 113 and draw power therefrom. A schematic/block diagram 201 of the connections in port 103 is illustrated in FIG. 2. Regulator 109 conditions the power to the application. In the scenario where the PDA has a common power requirement with the USB port, which in FIG. 2 is 5 VDC, conditioned power is connected to power connector 117 and USB port connector 113. Particularly, power is connected to pin 113P and ground connection is at 113G. Also shown is a resistor network 111, which is one of the embodiments and is also referred throughout as a second or alternate regulator, which loads data pins 113D1 and 113D2 to emulate a USB connection. This is often necessary for some USB devices to recognize the USB port and accept a charge therefrom.

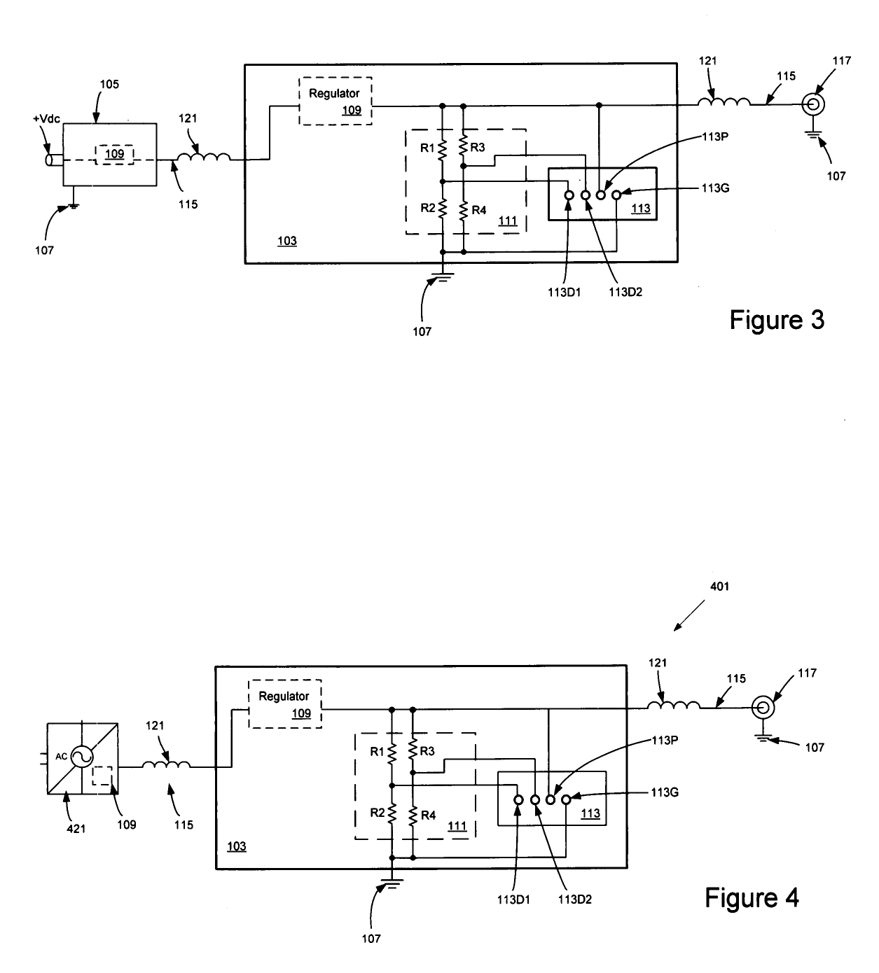

FIG. 3 brings together the embodiments of FIGS. 1 and 2 in a configuration adapted for DC voltage applications. Power plug 105 draws power from the vehicle. However, it is understood, that power plug 105 could be configured for any voltage source having a power and a ground connection. Power is then connected to a power regulator 109 to step the voltage to the desirable level. In the scenario where desired power at connector 117 and USB are the same, a single regulator 109 may be employed. It is up to the user where to place regulator 109. Given enough room, regulator 109 could reside at connector 105. However in an alternate embodiment, it could reside at the USB block 103. FIG. 3 shows regulators at blocks 105 and 103, however, it is understood that this is for illustration purposes. Although two regulators may be used, typically only one is required, residing either USB port 103 or power connector 105. Power is conducted to USB block 103 via a ground conductor and a power conductor pair 115, which may also employ one or more coiled segments 121. USB block 103 employs USB port 113. Pin 113P is connected to regulated voltage source from regulator 109 and provides power at USB port 113, which is configured for power supply. Similarly, pin 113G is connected to ground 107, providing a ground connection to the charging device. At or near the location of port 113 is a resistive network 111, which is used to condition and emulate data on USB port 103 data pins 113D1 and 113D2. Connecting power to pins 113D1 and 113D2 through the resistor bridge 111 provides a voltage level at these pins, which is necessary for some devices to see in order to take charge from pins 113P and 113G. Note that the target voltage level on 113D1 is approximately 2.6 VDC and target voltage on 113D2 is approximately 2.0 VDC. Of course other voltages, depending on the application, could be changed by changing values of R1 and R2 as well as R3 and R4 pairs. Notably, resistive bridge 111 is located at the vicinity of USB port 113, as opposed to connector 105. This provides the advantage of stepping the voltage at the port 113, instead of at connector 105. Thus, conductor 115 and/or 121 do not have to comprise an additional pair of wires to supply conditioned voltage to pins 113D1 and 113D2. Finally, as shown in FIG. 3, regulated power from regulator 109 is brought to power connector 117, which may be configured as a standardized or proprietary power connector, such as SCI connector as one example, although there are many others.

The embodiment shown in FIG. 4 is similar to the embodiment of FIG. 3. It is configured to tap into high voltage power, such as wall AC outlets. The reader will note that the embodiment of FIG. 4 employs an AC power connector 421. AC voltage is rectified and then regulated, as shown by block 109. As before, regulator 109 could be located at connector 421 or at or near USB port 113. With the difference noted herein, the embodiment of FIG. 4 functions the same as the embodiment described under FIG. 3 above.

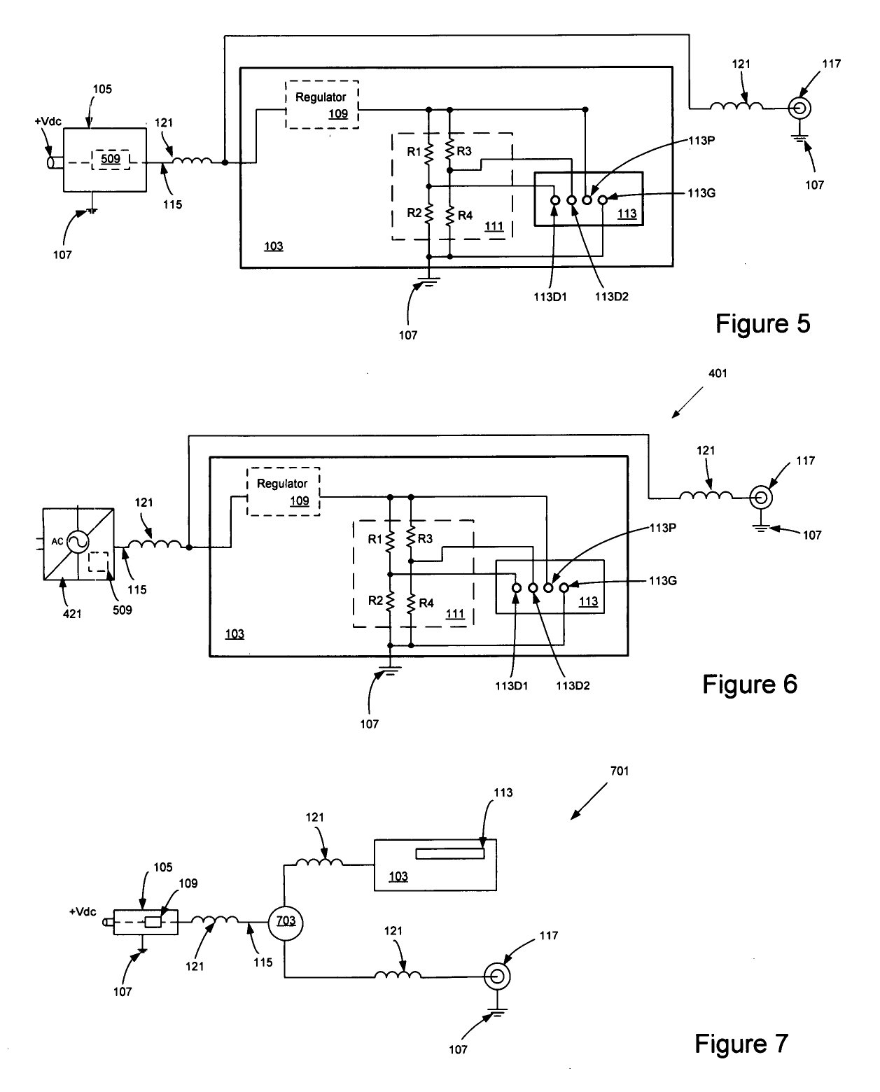

Some PDA's require charging voltage different than USB voltage. In these scenarios, two regulators 109 and 509 may be used. Shown in FIGS. 5 and 6 are embodiments similar to those in FIGS. 3 and 4 respectively. In these embodiments the reader will note that power to connector 117 is drawn from regulator 109 and power to block 103 is further conditioned by regulator 509 to bring the voltage to pins 113 into USB parameters described above. As in the prior embodiments, locating resistive network 111 as well as regulator 109 at or near USB port 113 provides efficiency because in the alternative, locating the bridge 111 near regulator 509 located at connectors 421 or 105 would require additional conductors/wiring necessary for the power requirements and data emulation at pins 113.

In another embodiment illustrated in FIG. 7, power adaptor 701 is shown in Y configuration. The leg of adaptor 701 is connected to a power connector 105 or 421 (not shown). Power is conditioned and regulated as described above and provided to a hub 703 via conductor 115 and/or 121. Hub 703 branches the power to USB block 103 and its USB port 113 as described above. As above, resistive network 111 is located at or near USB port 113 to eliminate additional wiring. Also as described above, regulator 109 could be positioned at connector 105, or in the case of this embodiment at hub 703. In both of these embodiments, only two wires are needed to provide power to all the connectors and ports. As before, this embodiment benefits from the resistance network 111 at or near USB port 113, as only two wires are required to be supplied to block 103. On the other hand of the Y 701, power is branched to connector 117. In this embodiment, using coiled conductors 121 at one or both hans of Y 701 allows a degree of freedom and movement to accommodate the environment and the PDA's using device 701.

While the present invention has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth. Many variations and modifications may be made to the above-described embodiment(s) without departing substantially from the spirit and principles of the invention. All such modifications and variations are intended to be included herein within the scope of this disclosure and protected by the following claims.

I claim:

1. A power adaptor comprising:
a) a first power connector configured to draw power from a power source;
b) a first regulator electrically connected to said power source and providing a first conditioned power level to a second regulator and to at least one second power connector through a conductor pair comprising a power conductor and a ground conductor;
c) said second regulator positioned proximate to a USB port and further conditioning said first conditioned power level by providing at least one second power level, wherein said second power level is electrically connected to at least one USB data pin of said USB port,
d) so that only said single conductor pair is sufficient between said first power connector, said USB port and said at least one second power connector.

2. The power adaptor of claim 1 wherein said USB port further comprises a power pin and a ground pin, said power pin electrically connected to said first conditioned power level and said ground pin electrically connected to said ground conductor.

3. The power adaptor of claim 1 wherein said first power connector is configured for a DC power connector.

4. The power adaptor of claim 1 where said first power connector is configured for an AC power connector.

5. The power adaptor of claim 1 wherein said second regulator comprises at least one resistor network configured as a voltage divider to change said first conditioned power level to said at least one second conditioned power level.

6. The power adaptor of claim 1 wherein said second regulator further comprises a first resistor voltage divider providing said second conditioned power level coupled to said first data pin of said USB port; and a second resistor voltage divider providing a third conditioned power level coupled to a second data pin of said USB port; said second and third power levels configured to emulate data power levels on said USB port thereby allowing a USB compliant PDA to accept said first power level through a power pin and a ground pin of said USB port.

7. The power adaptor of claim 1 wherein said first and said second regulators are positioned proximate to said USB port.

8. The power adaptor of claim 1 wherein said power adaptor is configured as a charger for at least one PDA.

9. A power adaptor comprising:
a) a first power connector configured to draw power from a power source;
b) a first regulator electrically connected to said power source and providing a first conditioned power level to a second regulator and to at least one second power connector through a conductor pair comprising a power conductor and a ground conductor;
c) said second regulator further conditioning said first conditioned power level and providing at least one second power level connected to a power pin of a USB port;
d) a third regulator electrically connected to said second regulator, further conditioning said second power level to at least one third power level wherein said at least one third power level is electrically connected to at least one USB data pin of said USB port;
e) wherein said second regulator and said third regulator are positioned proximate to said USB port, so that only said single conductor pair is sufficient between said first power connector and said USB port an said at least one second power connector.

10. The power adaptor of claim 9 wherein said USB port further comprises a ground pin, said ground pin electrically connected to said ground conductor.

11. The power adaptor of claim 9 wherein said first power connector is configured for a DC power connector.

12. The power adaptor of claim 9 where said first power connector is configured for a AC power connector.

13. The power adaptor of claim 9 wherein said third regulator comprises at least one resistor network configured as a voltage divider to change said second conditioned power level to said at least one third conditioned power level.

14. The power adaptor of claim 9 wherein said third regulator further comprises a first resistor voltage divider providing said third conditioned power level coupled to said first data pin of said USB port; and a second resistor voltage divider providing a fourth conditioned power level coupled to a second data pin of said USB port; said third and fourth power levels configured to emulate data power levels on said USB port thereby allowing a USB compliant PDA to accept said second power level through a power pin and a ground pin of said USB port.

15. The power adaptor of claim 9 wherein said first, said second and said third regulators are positioned proximate to said USB port.

16. The power adaptor of claim 9 wherein said power adaptor is configured as a charger for at least one PDA.

17. A power adaptor comprising:
a) a first power connector means for drawing power from a power source;
b) a first regulator means electrically connected to said power source for providing a first conditioned power level to a second regulator means and to at least one second power connector means for electrically connecting to at least one PDA through a conductor pair comprising a power conductor and a ground conductor;
c) said second regulator means further conditioning said first conditioned power level provided by said first regulator means by providing at least one second power level, wherein said second power level is connected to at least one USB data pin of said USB port;
d) so that only said single conductor pair is sufficient between said first power connector means, said USB port and said at least one second power connector means.

18. The power adaptor of claim 17 wherein said USB port further comprises a power pin and a ground pin, said power pin electrically connected to said first conditioned power level and said ground pin electrically connected to said ground conductor.

19. The power adaptor of claim 17 wherein said second regulator means comprises at least one resistor network means for changing said first conditioned power level to said at least one second conditioned power level.

20. The power adaptor of claim 17 wherein said second regulator means further comprises a first resistor voltage divider means for providing said second conditioned power level coupled to said first data pin of said USB port; and a second resistor voltage divider means for providing a third conditioned power level coupled to a second data pin of said USB port; said second and third power levels configured to emulate data power levels on said USB port thereby allowing a USB compliant PDA to accept said first power level through a power pin and a ground pin of said USB port.

21. The power adaptor of claim 17 wherein said first and said second regulator means are positioned proximate to said USB port.

22. The power adaptor of claim 17 wherein said power adaptor means is configured as a charger for at least one PDA.
